(19) United States
(12) Patent Application Publication
(10) Pub. No.: US 2025/0193881 A1
(43) Pub. Date: Jun. 12, 2025

(54) BASE STATION APPARATUS, CONTROL METHOD, AND COMPUTER-READABLE STORAGE MEDIUM THAT PROVIDE SETTING INFORMATION FOR ESTIMATING POSITION OF TERMINAL APPARATUS

(71) Applicant: KDDI CORPORATION, Tokyo (JP)

(72) Inventors: Masahito UMEHARA, Tokyo (JP); Masaya SHIBAYAMA, Tokyo (JP)

(21) Appl. No.: 19/051,483

(22) Filed: Feb. 12, 2025

Related U.S. Application Data
(63) Continuation of application No. PCT/JP2023/005169, filed on Feb. 15, 2023.

(30) Foreign Application Priority Data
Sep. 20, 2022 (JP) 2022-149506

(51) Int. Cl. H04W 72/1268; H04W 64/00; H04W 72/0446

(52) U.S. Cl. CPC H04W 72/1268; H04W 64/00; H04W 72/0446

(57) ABSTRACT

A base station apparatus connects the base station apparatus to a terminal apparatus in a first frequency band, notifies the terminal apparatus of first setting information for causing the terminal apparatus to transmit an SRS (sounding reference signal) in a second frequency band different from the first frequency band, and notifies another base station apparatus that operates in the second frequency band of second setting information for measuring the SRS.

### CROSS-REFERENCE TO RELATED APPLICATION(S)

This application is a continuation of International Patent Application No. PCT/JP2023/005169 filed on Feb. 15, 2023, which claims priority to and the benefit of Japanese Patent Application No. 2022-149506 filed on Sep. 20, 2022, the entire disclosures of which are incorporated herein by reference.

### BACKGROUND OF THE INVENTION

### Field of the Invention

The present invention relates to a technique for estimating the position of a terminal apparatus.

### Description of the Related Art

In wireless communication systems, the position of a terminal apparatus is specified, and thereby a communication service corresponding to the position can be provided to the terminal apparatus. A terminal apparatus can specify the position thereof by measuring radio waves transmitted from an artificial satellite, using GNSS (global navigation satellite system), for example, and notify information regarding the specified position to a network via a base station apparatus. On the other hand, there may be a case where a terminal apparatus cannot use GNSS measurement, a case where a GNSS measurement function is disabled, and the like. In such cases, for example, it is possible to use a RAN (radio access network)-based position estimation technique in which a plurality of base station apparatuses measure a radio signal transmitted from the terminal apparatus, and estimate the position of the terminal apparatus based on the difference in timing when the radio waves arrive the base station apparatuses (propagation time) and directions of arrival.

The estimation accuracy of the RAN-based position estimation technique may vary depending on a frequency property, the shape of an antenna, and the like. On the other hand, transmission setting of a radio signal for estimating the position of a terminal apparatus can be performed only in the frequency band of the cell in which the terminal apparatus is located. For this reason, even when a frequency band in which more accurate position estimation is possible is available at the position of the terminal apparatus, it is not possible to use the position estimation in the frequency band.

### SUMMARY OF THE INVENTION

The present invention provides a technique that makes it possible to perform position estimation based on a radio signal transmitted by a terminal apparatus, in a frequency band different from a frequency band of a cell in which the terminal apparatus is located.

A base station device according to the present invention comprises a connection unit configured to connect the base station apparatus to a terminal apparatus in a first frequency band; and a notification unit configured to notify the terminal apparatus of first setting information for causing the terminal apparatus to transmit an SRS (sounding reference signal) in a second frequency band different from the first frequency band, and notify another base station apparatus that operates in the second frequency band of second setting information for measuring the SRS.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing a configuration example of a wireless communication system;

FIG. 2 is a diagram describing a procedure for determining a scaling factor of a timing advance value;

FIG. 3 is a diagram showing an exemplary hardware configuration of an apparatus;

FIG. 4 is a diagram showing an exemplary functional configuration of a base station apparatus of a first frequency band;

FIG. 5 is a diagram showing an exemplary functional configuration of a base station apparatus of a second frequency band;

FIG. 6 is a diagram showing an exemplary functional configuration of a terminal apparatus; and

FIG. 7 is a diagram showing an example of a flow of processing that is executed in the wireless communication system.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Configuration

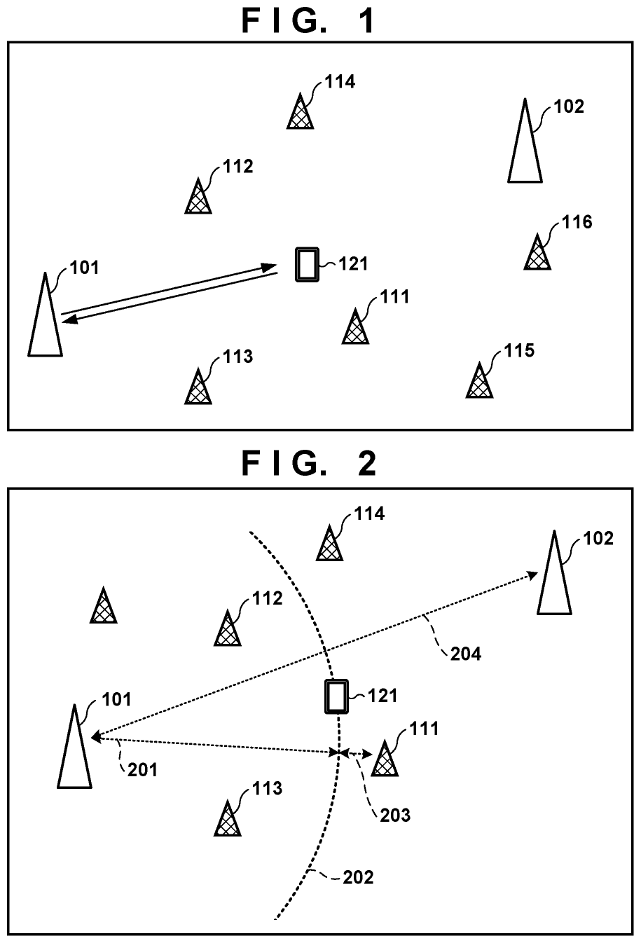

FIG. 1 shows a configuration example of a wireless communication system according to the present embodiment. The wireless communication system may be, for example, a cellular communication system that includes base station apparatuses 101 and 102 that provide communication services in a first frequency band and base station apparatuses 111 to 116 that provide communication services in a second frequency band. A terminal apparatus 121 is a terminal apparatus of the cellular communication system, and can use both the first frequency band and the second frequency band, and receive a wireless communication service by being connected to one of the base station apparatuses 101 and 102 or one of the base station apparatuses 111 to 116. Note that the cellular communication system may be configured in compliance with an existing standard of LTE (long term evolution), 5G (fifth generation), or the like, or a successor standard thereof, for example, and the first frequency band and the second frequency band may be frequency bands stipulated based on the standard.

Here, assume that the terminal apparatus 121 is located within the cell formed by the base station apparatus 101. The base station apparatus 101 usually provides setting information for communication in the first frequency band in which the base station apparatus 101 provides communication services, to the terminal apparatus 121 that has entered a connection state. In the first frequency band, the terminal apparatus 121 communicates with the base station apparatus 101 based on this setting information, and transmits a predetermined signal such as an SRS (sounding reference signal). The base station apparatus 101 can specify the state of a channel by measuring the SRS. In addition, the base station apparatus 101 can specify an SRS receiving timing and arrival direction, for example, and estimate the position of the terminal apparatus 121 based on an SRS receiving timing and arrival direction specified similarly by another base station apparatus that uses the first frequency band (the base station apparatus 102 or the like). The base station apparatus 101 may perform position estimation, for example, based on the difference in arrival time of radio waves between the receiving timing specified by the other base station apparatus and the receiving timing specified by the base station apparatus 101 itself. In addition, the base station apparatus 101 may perform position estimation based on the arrival direction specified by the other base station apparatus and the arrival direction specified by the base station apparatus 101 itself.

On the other hand, in a case where the second frequency band is a frequency band that is higher than the first frequency band, the attenuation of radio waves in the second frequency band is greater than that in the first frequency band, and, due to the linearity of radio waves and the like, the propagation distance of radio waves in the second frequency band may be shorter than that in the first frequency band. For this reason, the density at which the base station apparatuses 111 to 116 are arranged may be higher than the density at which the base station apparatuses 101 and 102 are arranged. In such a case, the terminal apparatus 121 transmits an SRS in the second frequency band, and the base station apparatuses 111 to 116 measure the SRS, thereby making it possible to more accurately estimate the position of the terminal apparatus 121.

However, the terminal apparatus 121 is located in the cell formed by the base station apparatus 101 that operates in the first frequency band, and thus receives, from the base station apparatus 101, setting information for transmission the SRS in the first frequency band. In addition, the terminal apparatus 121 usually needs to be connected to one of the base station apparatuses 111 to 116 in order to transmit the SRS in the second frequency band. In contrast, in the present embodiment, the base station apparatus 101 that operates in the first frequency band performs setting for transmission of the SRS in the second frequency band. Based on this setting, the terminal apparatus 121 can transmit the SRS in the second frequency band without being connected to a base station apparatus of the second frequency band.

The base station apparatus 101 may perform notification of information regarding transmission power as setting of the SRS in the second frequency band, for example. In an example, the base station apparatus 101 may generate SRS setting information in the second frequency band in accordance with which the terminal apparatus 121 transmits the SRS with the maximum transmit power available, and notify the terminal apparatus 121 of the SRS setting information. In addition, in a case where the base station apparatus 101 is located at the same position as a base station apparatus of the second frequency band, for example, the base station apparatus 101 may generate setting information designating that the same transmission power as the transmission power of the SRS in the first frequency band is to be used for transmission of the SRS in the second frequency band, and notify the terminal apparatus 121 of the generated setting information. In addition, for example, also in a case where the base station apparatus 101 is located at a position different from a base station apparatus of the second frequency band, the base station apparatus 101 may use the same transmission power as the transmission power of the SRS in the first frequency band, for transmission of the SRS in the second frequency band, and furthermore, for example, the base station apparatus 101 may generate setting information designating that repeated transmission (repetition) is to be performed, and notify the terminal apparatus 121 of the generated setting information. The base station apparatus 101 may prepare an SRS-Config information element for the second frequency band, in an RRC (radio resource control) message, add the number of times of repetition (repetitionFactor) to the information element, and perform notification to the terminal apparatus 121, for example. In addition, for example, a value determined for each frequency band in advance may be used as the number of times of repetition.

In addition, the base station apparatus 101 may perform notification of information regarding a transmission timing (TA (timing advance)) as setting of the SRS in the second frequency band, for example. In a case where, for example, the base station apparatus 101 is located at the same position as a base station apparatus of the second frequency band, the base station apparatus 101 may notify the terminal apparatus 121 of a TA value in the first frequency band set by the base station apparatus 101 itself, or a value obtained by multiplying the TA value by a predetermined scaling factor, as a TA value for when transmitting the SRS in the second frequency band. In an example, if the TA value in the first frequency band is smaller than a predetermined value, the base station apparatus 101 may notify the TA value as is to the terminal apparatus 121, as a TA value for when transmitting the SRS in the second frequency band. On the other hand, if the TA value in the first frequency band is greater than the predetermined value, the base station apparatus 101 may notify the terminal apparatus 121 of a value obtained by multiplying the TA value by a scaling factor that is smaller than 1, as a TA value for when transmitting the SRS in the second frequency band. If the TA value in the first frequency band is greater than the predetermined value, it is envisioned that the position of the terminal apparatus 121 is distant from the base station apparatus 101 by a certain distance or longer. Here, in a case where the base station apparatuses of the second frequency band are arranged with a higher density than the base station apparatuses of the first frequency band, it is envisioned that the distance from the terminal apparatus 121 to a base station apparatus of the second frequency band is shorter than the distance from the terminal apparatus 121 to the base station apparatus 101. If the TA value in the first frequency band is used as is in such a state, an SRS receiving timing of the base station apparatus of the second frequency band becomes significantly earlier than the frame timing, which may result in the inability to accurately detect the SRS. For this reason, if the TA value in the first frequency band is greater than the predetermined value, the TA value in the first frequency band is made smaller by multiplying the TA value by a scaling factor that is smaller than 1, thereby making it possible to prevent the SRS receiving timing from becoming significantly earlier than the frame timing.

Note that, for example, the base station apparatus 101 may set, as the above predetermined value, the maximum value of the TA value in the second frequency band defined based on the size of the coverage area of the base station apparatus of the second frequency band. If the TA value in the first frequency band exceeds the predetermined value set to the maximum value of the TA value in the second frequency band, it is envisioned that the terminal apparatus 121 is outside the cell provided by the base station apparatus of the second frequency band that at the same position as the base station apparatus 101, and is located near another base station apparatus of the second frequency band. For this reason, in such a case, the base station apparatus 101 may determine a value obtained by multiplying the TA value in the first frequency band by a scaling factor, as a TA value in the second frequency band such that the other base station apparatus of the second frequency band can accurately receive the SRS.

An example of a method for specifying a scaling factor will be described with reference to FIG. 2. Note that, in the following description, the TA value in the first frequency band is greater than the predetermined value, and the terminal apparatus 121 is located at a position distant from the base station apparatus 101 and a base station apparatus of the second frequency band located at the same position as the base station apparatus 101. For this reason, no particular mention is made regarding the base station apparatus of the second frequency band located at the same position as the base station apparatus 101.

First, the base station apparatus 101 obtains an estimated distance value 201, that is the value of an estimated distance between the base station apparatus 101 and the terminal apparatus 121, based on the TA value for the SRS in the first frequency band. The base station apparatus 101 then specifies an arc 202 that indicates positions located at a distance of the estimated distance value 201 from the base station apparatus 101. Here, the terminal apparatus 121 is expected to be located on the arc 202. The base station apparatus 101 specifies the base station apparatus 111 of the second frequency band located at a position closest to the arc, and specifies the distance between the base station apparatus 111 and the arc 202, as the shortest distance 203 between the base station apparatus of the second frequency band and the terminal apparatus. In addition, the base station apparatus 101 specifies a distance 204 to the base station apparatus 102 adjacent thereto, from among the base station apparatuses of the first frequency band. Note that the base station apparatus 101 may specify, for example, a base station apparatus of the first frequency band that is closest to the base station apparatus of the second frequency band referred to when the shortest distance 203 was specified (in this case, the base station apparatus 111), and is other than the base station apparatus 101, and specify the distance to the specified base station apparatus as the distance 204. The base station apparatus 101 then calculates a scaling factor=(the shortest distance 203/the distance 204), for example. In an example, when the shortest distance 203 is 20 meters and the distance 204 between the base station apparatuses of the first frequency band is 200 meters, the scaling factor may be calculated as 1/10 (=0.1). In addition, the base station apparatus 101 may calculate the distance between two base station apparatuses of the second frequency band or the distance corresponding to the size of the cell formed by the base station apparatus of the second frequency band, in place of the above shortest distance 203. In addition, for example, the average value of distances between the above arc 202 and a plurality of base station apparatuses of the second frequency band may be used in place of the above shortest distance 203.

In addition, the base station apparatus 101 may specify the approximate position of the terminal apparatus 121 based on the SRS transmitted from the terminal apparatus 121 in the first frequency band, for example, and specify the TA value in the second frequency band based on the specified position and the position of a base station apparatus of the second frequency band. In this case, for example, based on the distance between the position of the base station apparatus of the second frequency band located at a position closest to the terminal apparatus 121 and the position of the terminal apparatus 121, the above scaling factor may be calculated and the TA value in the second frequency band may be specified. In addition, the value obtained by dividing the distance between the position of the base station apparatus of the second frequency band located at a position closest to the terminal apparatus 121 and the position of the terminal apparatus 121 by the speed of light may be converted into a TA value. Note that, also in a case where no base station apparatus of the second frequency band is located at the same position as the base station apparatus 101, the TA value calculated using the scaling factor or the speed of light as described above may be used.

In addition, the base station apparatus 101 may notify the terminal apparatus 121 of information regarding a frequency at which the SRS is to be transmitted, as setting of the SRS in the second frequency band, for example, in addition to the information regarding the transmission power and the timing advance, which have been described above. The information regarding the frequency at which the SRS is to be transmitted may include information indicating an SRS ARFCN (absolute radio frequency channel number) and a bandwidth (SRS bandwidth), for example.

Note that the setting information for the SRS in the second frequency band notified to the terminal apparatus 121 by the base station apparatus 101 may be notified to a base station apparatus of the second frequency band that may detect the SRS from the terminal apparatus 121. Note that such information is shared by a plurality of cells among which different frequency bands are used, and thus the information may be defined such that identification information (SRS resource ID) with which a resource for the SRS is specified is associated with the frequency and time resource of the SRS corresponding thereto. A plurality of such combinations of SRS resource ID and corresponding frequency and time resource are the prepared, and an SRS resource ID group for position estimation is formed, for example. Information regarding combinations of SRS resource ID and frequency and time resource included in the SRS resource ID group may be shared between base station apparatuses of different frequency bands in advance. The information regarding combinations of SRS resource ID and corresponding frequency and time resource included in the SRS resource ID group is shared among the base station apparatuses 101 and 102 that operate in the first frequency band and the base station apparatuses 111 to 116 that operate in the second frequency band, for example. After that, for example, the base station apparatus 101 determines a frequency and time resource corresponding to one of the SRS resource IDs included in the SRS resource ID group, as a frequency at which the terminal apparatus 121 is to transmit the SRS and a time resource with which the terminal apparatus 121 is to transmit the SRS, and notifies the terminal apparatus 121 of the frequency and time resource. The base station apparatus 101 then notifies the SRS resource ID corresponding to the frequency and time resource notified to the terminal apparatus 121, to a base station apparatus of the second frequency band that detects the SRS from the terminal apparatus 121. Note that information that is used when detecting the SRS, such as information regarding a sequence that is used for a terminal apparatus to generate an SRS, may be shared between base station apparatuses. Note that a base station apparatus of the second frequency band may perform detection processing using the entire sequence for generation of an SRS that may be used for position estimation, and, in this case, information regarding the sequence does not need to be shared. Information may be shared between base station apparatuses through an interface between the base station apparatuses, such as an Xn interface or an NG interface.

In addition, for example, for power saving, some of the base station apparatuses of the second frequency band may be brought into a sleep state. In this case, base station apparatuses that share information for estimating the position of the terminal apparatus 121 may be set such that at least a receiving function is activated to enable the execution of SRS measurement.

### Apparatus Configuration

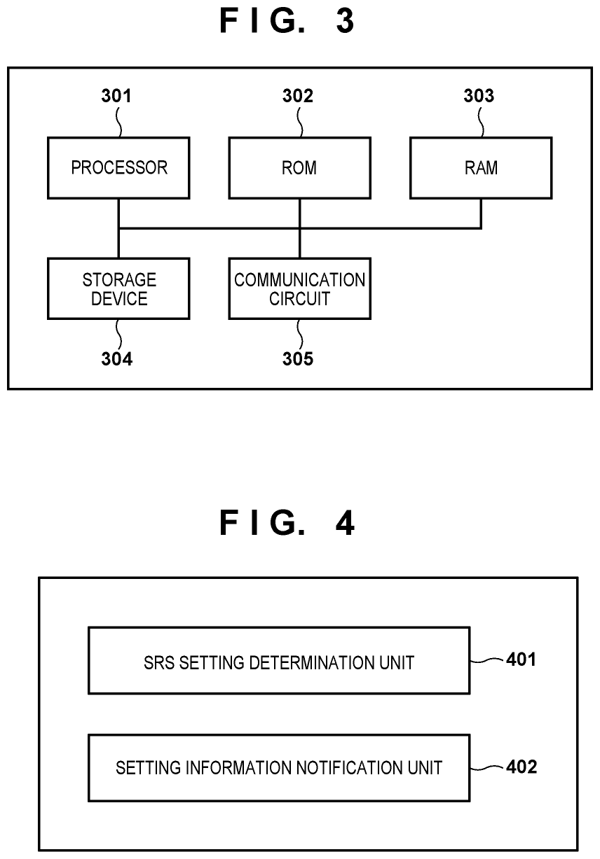

FIG. 3 is a diagram showing an exemplary hardware configuration of base station apparatuses (the base station apparatuses 101 and 102 that operate in the first frequency band and the base station apparatuses 111 to 116 that operate in the second frequency band) and the terminal apparatus 121. In an example, the base station apparatuses and the terminal apparatus each include a processor 301, a ROM 302, a RAM 303, a storage device 304, and a communication circuit 305. The processor 301 is a computer that includes one or more processing circuits, such as a general-purpose CPU (central processing unit) and an ASIC (application specific integrated circuit), and executes overall processing of the apparatus and above-described processing by reading and executing a program stored in the ROM 302 or the storage device 304. The ROM 302 is a read-only memory that stores information such as programs, various parameters, and the like related to processing that is executed by the base station apparatus or the terminal apparatus. The RAM 303 is a random-access memory that functions as a workspace when the processor 301 executes a program, and stores temporary information. The storage device 304 is constituted by a detachable external storage device, for example. The communication circuit 305 is constituted by a circuit for wireless communication that complies with a cellular communication standard of LTE or 5G, or a successor thereof, for example. Note that FIG. 3 illustrates one communication circuit 305, but the base station apparatuses and the terminal apparatus may each include a plurality of communication circuits. The base station apparatuses and the terminal apparatus may each include a plurality of wireless communication circuits and antennas for the LTE standard, the 5G standard, a successor standard thereof, and the like, respectively.

FIG. 4 is a diagram showing an exemplary functional configuration of a base station apparatus (the base station apparatus 101 or 102) that operates in the first frequency band. Each base station apparatus of the first frequency band includes, for example, an SRS setting determination unit 401 and a setting information notification unit 402. Note that these functional units can be implemented, for example, by the processor 301 executing a program stored in the ROM 302 or the storage device 304. Note that there is no limitation thereto, and, for example, some or all of these functional units may be implemented using dedicated hardware. Note that processing that is to be executed by the base station apparatus of the first frequency band has been described above, and thus, here, a functional configuration of the base station apparatus of the first frequency band is only outlined briefly.

The SRS setting determination unit 401 determines setting information of the SRS to be transmitted to the terminal apparatus in the second frequency band. The SRS setting determination unit 401 determines setting information such as transmission power for the SRS, a timing advance value, a frequency and time resource that are to be used, and a sequence that is to be used for generation of the SRS, as described above. The setting information notification unit 402 notifies the terminal apparatus of the setting information determined by the SRS setting determination unit 401. In addition, the setting information notification unit 402 may notify the base station apparatus of the second frequency band, for example, of a portion of setting information such as a frequency and time resources to be used for transmission of the SRS.

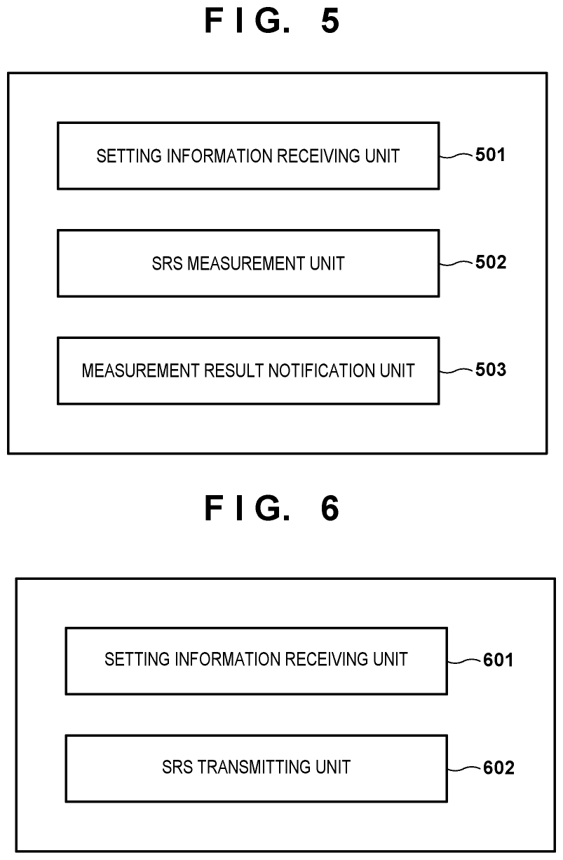

FIG. 5 is a diagram showing an exemplary functional configuration of the base station apparatuses (the base station apparatuses 111 to 116) that operates in the second frequency band. The base station apparatuses of the second frequency band each include, for example, a setting information receiving unit 501, an SRS measurement unit 502, and a measurement result notification unit 503. Note that these functional units may be implemented, for example, by the processor 301 executing a program stored in the ROM 302 or the storage device 304. Note that there is no limitation thereto, and, for example, some or all of these functional units may be implemented using dedicated hardware. Note that processing that is to be executed by the base station apparatus of the second frequency band has been described above, and thus, here, a functional configuration of the base station apparatus of the second frequency band is only outlined briefly.

The setting information receiving unit 501 receives setting information regarding the SRS for position estimation to be transmitted by a terminal apparatus, from a base station apparatus of the first frequency band. The setting information may include a frequency at which the SRS is to be transmitted and a time resource with which the SRS is to be transmitted, information regarding a sequence that is used for generation of the SRS, and the like. The SRS measurement unit 502 measures the SRS transmitted from the terminal apparatus based on the setting information notified by the setting information receiving unit 501. Note that the SRS measurement unit 502 may obtain, for example, an SRS receiving timing and an SRS arrival direction through the measurement. The measurement result notification unit 503 notifies a result of measurement performed by the SRS measurement unit 502 to an apparatus that executes processing for position estimation. Note that the base station apparatus may have, for example, a function of collecting a result of measurement from another base station apparatus, and thereby estimating the position of the terminal apparatus in place of the measurement result notification unit 503. Note that position estimation may be performed using a conventional technique that is based on an arrival time difference and arrival directions, for example.

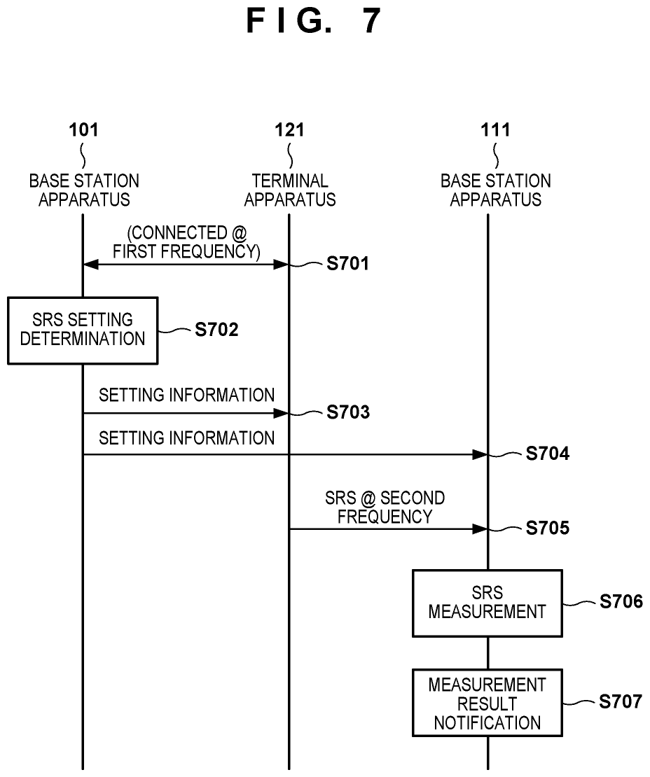

FIG. 6 is a diagram showing an exemplary functional configuration of a terminal apparatus that is a position estimation target (the terminal apparatus 121). The terminal apparatus includes, for example, a setting information receiving unit 601 and an SRS transmitting unit 602. Note that these functional units may be implemented, for example, by the processor 301 executing a program stored in the ROM 302 or the storage device 304. Note that there is no limitation thereto, and, for example, some or all of these functional units may be implemented using dedicated hardware. Note that processing that is to be executed by the terminal apparatus of the second frequency band has been described above, and thus, here, a functional configuration of the terminal apparatus of the second frequency band is only outlined briefly.

The setting information receiving unit 601 receives setting information for transmitting the SRS, from the base station apparatus of the first frequency band. This setting information may include information such as transmission power, a timing advance value, a frequency and time resource, and a sequence such as those described above. The SRS transmitting unit 602 generates and transmits the SRS based on the setting information received by the setting information receiving unit 601.

### Flow of Processing

Next, an example of a flow of processing that is executed by in the wireless communication system will be described with reference to FIG. 7. Note that there are a plurality of (for example, three or more) base station apparatuses that operate in the second frequency band as a matter of course, but FIG. 7 shows only the base station apparatus 111 as a base station apparatus of the second frequency band for ease of description.

In this processing, the base station apparatus 101 is connected to the terminal apparatus 121 in the first frequency band (step S701). Assume that setting has been performed in this state such that position estimation is performed in accordance with an instruction from a network or at a predetermined time interval, for example, and, when a time at which the estimation is to be performed comes, the base station apparatus 101 determines that the position of the terminal apparatus 121 is to be estimated. If it is determined that the position of the terminal apparatus 121 is to be estimated, the base station apparatus 101 performs determination on setting of the SRS that is to be transmitted in the second frequency band by the terminal apparatus 121 (step S702). The base station apparatus 101 determines a frequency at which the terminal apparatus 121 is to transmit the SRS and a time resource with which the terminal apparatus 121 is to transmit the SRS, transmission power, a timing advance value, a sequence to be used for generation of the SRS, and the like. The base station apparatus 101 then notifies the terminal apparatus 121 of setting information indicating the determined settings through wireless communication in the first frequency band (step S703). Note that the base station apparatus 101 notifies at least a portion of the setting information to the base station apparatus 111 of the second frequency band, for example, using the Xn interface or the NG interface (step S704). The base station apparatus 101 transmits, to the base station apparatus 111, information indicating a frequency at which the SRS is to be transmitted and a time resource with which the SRS is to be transmitted, information regarding a sequence that is used for generation of the SRS, and the like.

After that, the terminal apparatus 121 transmits the SRS in the second frequency band based on the setting information received in step S703 (step S705). The base station apparatus 111 of the second frequency band then measures the SRS (step S706), and notifies the measurement result to an apparatus that executes position estimation (step S707).

By adopting the above configuration, it is possible to cause the terminal apparatus to transmit an SRS (sounding reference signal) in a frequency band different from that of the cell in which the terminal apparatus is located, and perform position estimation based on the reference signal. This makes it possible to contribute to Goal 9 of Sustainable Development Goals (SDGs) lead by the United Nations, which aims to “build resilient infrastructure, promote sustainable industrialization, and foster innovation.

According to the present invention, it is possible to perform position estimation based on a radio signal transmitted by a terminal apparatus, in a frequency band different from a frequency band of a cell in which the terminal apparatus is located.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A base station apparatus comprising:
a connection unit configured to connect the base station apparatus to a terminal apparatus in a first frequency band; and
a notification unit configured to notify the terminal apparatus of first setting information for causing the terminal apparatus to transmit an SRS (sounding reference signal) in a second frequency band different from the first frequency band, and notify another base station apparatus that operates in the second frequency band of second setting information for measuring the SRS.

2. The base station apparatus according to claim 1,
wherein the first setting information includes a TA (timing advance) value for when transmitting the SRS, and
in a case where the other base station apparatus is located at a same position as the base station apparatus and a first TA value in the first frequency band does not exceed a predetermined value, the notification unit notifies the terminal apparatus of the first TA value as a second TA value for when transmitting the SRS in the second frequency band.

3. The base station apparatus according to claim 2,
wherein, in at least one of a case where the other base station apparatus is not located at the same position as the base station apparatus and a case where the first TA value exceeds the predetermined value, the notification unit notifies the terminal apparatus of, as the second TA value, a value obtained by multiplying the first TA value by a scaling factor that is smaller than 1.

4. The base station apparatus according to claim 3,
wherein the scaling factor is a value obtained by dividing a distance between a position at a distance specified based on the first TA value from the base station apparatus and the other base station apparatus that operates in the second frequency band, by a distance between the base station apparatus and a second base station apparatus that operates in the first frequency band.

5. The base station apparatus according to claim 2,
wherein, in at least one of a case where the other base station apparatus is not located at the same position as the base station apparatus and a case where the first TA value exceeds the predetermined value, the notification notifies the terminal apparatus of, as the second TA value, a value specified based on a value obtained by dividing a distance between a position at a distance specified based on the first TA value from the base station apparatus and the other base station apparatus that operates in the second frequency band, by a speed of light.

6. The base station apparatus according to claim 1,
wherein the first setting information includes information regarding transmission power for when transmitting the SRS in the second frequency band, and
the notification unit notifies the terminal apparatus of a same value as a value of transmission power in the first frequency band, as a value of the transmission power for when transmitting the SRS in the second frequency band, and, in a case where the other base station apparatus that operates in the second frequency band is not located at the same position as the base station apparatus, notify the terminal apparatus of information for repeatedly transmitting the SRS.

7. The base station apparatus according to claim 1,
wherein the first setting information and the second setting information include information indicating a frequency at which the SRS is to be transmitted in the second frequency band and a time resource with which the SRS is to be transmitted in the second frequency band.

8. A control method executed by a base station apparatus, comprising:
connecting the base station apparatus to a terminal apparatus in a first frequency band;
notifying the terminal apparatus of first setting information for causing the terminal apparatus to transmit an SRS (sounding reference signal) in a second frequency band different from the first frequency band; and
notifying another base station apparatus that operates in the second frequency band of second setting information for measuring the SRS.

9. A non-transitory computer-readable storage medium that stores a computer program for causing a computer included in a base station apparatus to:
connect the base station apparatus to a terminal apparatus in a first frequency band;
notify the terminal apparatus of first setting information for causing the terminal apparatus to transmit an SRS (sounding reference signal) in a second frequency band different from the first frequency band; and
notify another base station apparatus that operates in the second frequency band of second setting information for measuring the SRS.
